(19) United States
(12) Patent Application Publication
(10) Pub. No.: US 2008/0129592 A1
(43) Pub. Date: Jun. 5, 2008

(54) Global Positioning Device With A Head Up Display

(76) Inventor: Deng-Yuan Wu, Rende Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/738,467

(22) Filed: Apr. 21, 2007

(30) Foreign Application Priority Data
Aug. 30, 2006 (TW) 095215441

(51) Int. Cl. G01S 1/00

(52) U.S. Cl. 342/357.12

(57) ABSTRACT

A global positioning device with a HUD comprises a GPS module, a bluetooth module, a first single chip microprocessor, a power source switch, a GPS display light, a rotation detecting circuit, a second single chip microprocessor, a light sensor, and a HUD. The HUD projects the information of the vehicle, such as speed, position, rotation, and time of stop, etc, onto the windscreen so that the driver may maintain a head-up position to improve the driving safety. The bluetooth module wirelessly transmits the data of the satellite positioning device to electronic products and mobile devices so that these equipments and the satellite are interconnected.

### BACKGROUND OF THE INVENTION

1. Field of the Invention

The present invention relates to a global positioning device with a HUD, and more particularly to a global positioning device with a HUD, which may project the information of the vehicle, such as speed, position, rotation, and time of stop, etc, onto the windscreen so that the driver may maintain a head-up position and keep concentrating on driving without lowering head from time to time to read the rotation meter and speed meter, thus improving driving safety. The bluetooth module wirelessly transmits the data of the satellite positioning device to electronic products and mobile devices for interconnecting these equipments and the satellite.

2. Description of the Prior Art

HUD (head up display) is an assistant instrument often used on an aircraft, which enables the pilot to read the important information without lowering his head. HUD is first used on military airplane for reducing the frequency that the pilot has to check the panel meters, thus preventing from being disturbed and failing to control situation awareness. For its convenience and safety, HUD is now used on many commercial airplanes and even on some automobiles in order to improve the driving safety.

HUD uses the principle of light reflection to project the important driving information onto the windscreen at a height approximately level to the driver's eyes. The projected words and images are adjusted to the infinite focal position, when looking forward through the HUD, the driver may easily mix the view outside the automobile with the information projected on the HUD, The design of the HUD is to allow the driver to maintain a head-up position to concentrate on driving without lowering head to read the meters, thereby reducing the frequency of lowering and raising head, and avoiding the uncomfortness caused by frequent adjustment of the eyes' focal length,

Bluetooth is one of the most popular wireless short: distance communication techniques in recent years and serves to provide an unobstructed wireless transmission environment which is operable worldwide. In addition to the replacement the wire communication, Bluetooth also provides interoperability between the equipments of different manufacturers. Theses equipments include many electronic products and mobile devices, and Bluetooth enables these equipments to be connected through various wireless data transmission.

The entire operation of the GPS (global positioning system) may be divided into three parts: outer space, ground, and signal. GPS calculates distance by measuring the wireless signal transmission time, and then position of satellites in the outer space is determined by the distance. This is an observing method of geostationary orbit and precise positioning.

The basis of GPS is triangulation from satellites. After knowing the position of the satellite through the precise satellite data, the user may receive the signal sending from the satellite and detect the signal transmission time. Since the signal is transmitted at the speed of light, the distance to the satellite may be worked out. GPS may transmit the signal containing time function and satellite radio data. From the position of the GPS satellite and the relative distance, the receiver may figure out its own position, speed and height. The receiver is very simple and only comprises a band antenna, a data processing unit, a display and an input unit. As long as the antenna is not interfered with or shielded and may receive more than three satellites at the same time, it may display the longitudinal and latitudinal positions.

TW Pat. No 094222884 discloses a vehicle information sensing and warning device, which is a sensing and warning device used on a vehicle and comprises a HUD and a GPS that are arranged above and beneath the panel of the steering wheel, respectively. The GPS includes a RF wireless receiver which may receive the laser frequency of the speed detecting radar outside the vehicle, and project the overspeed warning and various relative data onto the windscreen through the HUD with voice warning, allowing the driver to read it without lowering head, thereby improving the driving safety. The abovementioned HUD and GPS are independently arranged and connected via cable, the transmission cable may be seen above the panel, so the panel looks very messy. Further, the abovementioned vehicle information sensing and warning device and the electronic products or mobile device made by different manufactures also lack interoperability.

TW Pat. No 093214829 discloses a bluetooth satellite positioning device, one end of the Bluetooth device is electrically connected to the satellite positioning device through a connector adapter, and another end is electrically connected to a power source connector through a wire with a connector adapter. The Bluetooth device serves to wirelessly transmit the signal received from the satellite by the satellite positioning device to the PDA. However, the position of the PDA placed requires the driver to lower his head when reading the data of the PDA, his attention is distracted from driving, failing to control situation awareness.

TW Pat. No 094220992 discloses a HUD comprising a casing, a circuit unit and a transparent panel. The circuit unit and the transparent panel are superpositioned in the casing to reduce the thickness of the HUD, and the HUD is disposed between the driving seat and the windscreen. However, the HUD is not provided with GPS and Bluetooth device, so it is unable to show the longitudinal and latitudinal positions of the vehicle and is incapable of Bluetooth transmitting various data to provide interconnection.

The three abovementioned inventions are only provided with HUD and GPS without Bluetooth device, or only provided with Bluetooth and satellite positioning device without HUD, or only provided with HUD without bluetooth and satellite positioning device. Therefore, their functions are imperfect and wait to be improved.

The present invention has arisen to mitigate and/or obviate the afore-described disadvantages.

### SUMMARY OF THE INVENTION

A global positioning device with a HUD of the present invention comprises a GPS module, a bluetooth module, a first single chip microprocessor, a power source switch, a GPS display light, a rotation detecting circuit, a second single chip microprocessor, a light sensor, and a HUD. The GPS module has an input terminal electrically connected to a GPS antenna and a low noise amplifying circuit, respectively, and has an output terminal electrically connected to the bluetooth module and the first single chip microprocessor. The bluetooth module has an input terminal electrically connected to a bluetooth antenna. The first single chip microprocessor has an input terminal electrically connected to the GPS module, the bluetooth module, the power source switch and the rotation detecting circuit, and has an output terminal electrically connected to the GPS display light and the second single chip microprocessor. The power source switch is electrically connected to the input terminal of the first single chip microprocessor. The GPS display light is electrically connected to the output terminal of the first single chip microprocessor. The rotation detecting circuit has an input electrically connected to the input terminal of the first single chip microprocessor and has an output terminal electrically connected to the input terminal of a 12V vehicle power supply and power conversion circuit. The second single chip microprocessor has its input terminal electrically connected to the first single chip microprocessor and the light sensor. The light sensor is electrically connected to the input terminal of the second single chip microprocessor. The HUD is electrically connected to the output terminal of the second single chip microprocessor.

### BRIEF DESCRIPTION OF THE DRAWINGS

FIG. 1 is a block diagram of showing a global positioning device with a HUD in accordance with the present invention; and

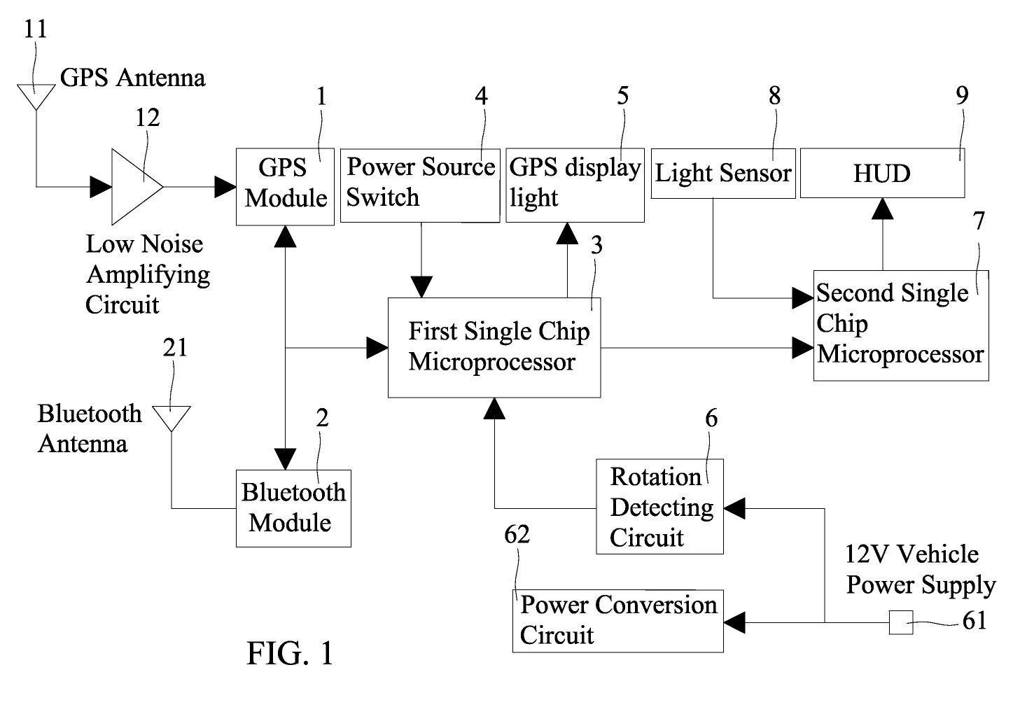

FIG. 2 is an illustrative view in accordance with the present invention of showing the information being projected onto the windscreen by the HUD.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

Referring to FIG. .1, a global positioning device with a HUD comprises a. GPS module 1, a. bluetooth module 2, a first single chip microprocessor 3, a power source switch 4, a GPS display light 5, a rotation

detecting circuit 6, a second single chip microprocessor 7, a light sensor 8, and a HUD 9.

The GPS module 1 has an input terminal electrically connected to a GPS antenna 11 and a low noise amplifying circuit 12, respectively, and has an output terminal electrically connected to the bluetooth module 2 and the first single chip microprocessor 3.

The bluetooth module 2 has an input terminal electrically connected to a bluetooth antenna 21. Signal is processed by the GPS module 1 and received by the bluetooth antenna and then wirelessly transmitted to electronic products and mobile devices.

The first single chip microprocessor 3 has an input terminal electrically to the GPS module i, the bluetooth module 2, the power source switch 4 and the rotation detecting circuit 6, and has an output terminal electrically connected to the GPS display light 5 and the second single chip microprocessor 7.

The power source switch 4 is electrically connected to the input terminal of the first single chip microprocessor 3.

The GPS display light 5 is electrically connected to the output terminal of the first single chip microprocessor 3 and serves to show whether the GPS antenna is receiving signal.

The rotation detecting circuit 6 has an input electrically connected to the input terminal of the first single chip microprocessor 3 and has an output terminal electrically connected to the input terminal of a 12V vehicle power supply 61 and power conversion circuit 62.

The second single chip microprocessor 7 has its input terminal electrically connected to the first single chip microprocessor 3 and the light sensor 8.

The light sensor 8 is electrically connected to the input terminal of the second single chip microprocessor 7 and serves to automatically adjust the luminance of the HUD 9 by sensing the environment lightness.

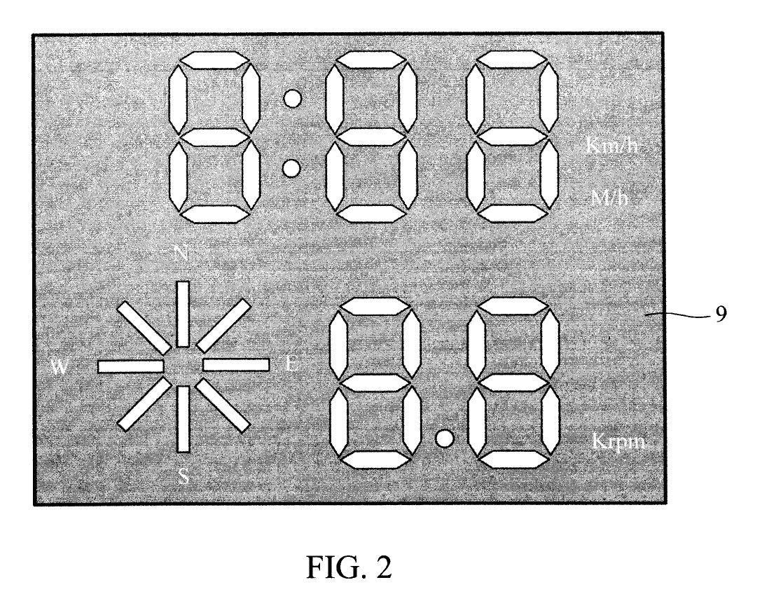

The HUD 9 is electrically connected to the output: terminal of the second single chip microprocessor 7 and serves to project the information of the vehicle, such as speed, position, rotation, and time of stop, etc, onto the windscreen, as shown in FIG. 2, so that the driver may maintain a head-up position and keep concentrating on driving without lowering head from time to time to read the rotation meter and speed meter, thus improving driving safety. The bluetooth module wirelessly transmits the display and the data of the satellite positioning device to electronic products and mobile devices so that these equipments and the satellite are interconnected.

To summarize, the global positioning device with a HUD has the following advantages:

First, the structure and technique content of the global positioning device with a HUD of the present invention are not found in or anticipated by similar products in the same field, therefore, the present invention is innovative.

Second, the HUD and the bluetooth are integrated into the global positioning device, therefore, the global positioning device is not only easy to use but also its function is improved.

Third, with the HUD, the user knows the information of the vehicle, such as speed, position, rotation, and time of stop, etc. The speed, position, and time of stop are known from the satellite signal received by the global satellite positioning device. The rotation of the vehicle is detected the rotation detecting circuit electrically connected to the input terminal of a 12V vehicle power supply. The global positioning device with a HUD allows the driver to maintain a head-up position to concentrate on driving without lowering head to read the meters, thereby reducing the frequency of lowering and raising head, avoiding the uncomfortness caused by frequent adjustment of the eyes' focal length, and ensuring a safe driving.

Fourth, the light sensor may automatically adjust the luminance of the HUD by sensing the environment lightness, and the light source of the HUD is LED.

Fifth, the global positioning device with a HUD of the present invention has a function of bluetooth automatic search, accordingly, it is energy saving.

Sixth, the global positioning device with a HUD of the present invention may be powered by a car charger.

Seventh, the global positioning device with a HUD of the present invention provides a function of automatic power on/off by checking the vehicle power supply.

While we have shown and described various embodiments in accordance with the present invention, it should be clear to those skilled in the art that further embodiments may be made without departing from the scope of the present invention.

What is claimed is:

1. A global positioning device with a HUD comprising a GPS module, a bluetooth module, a first single chip microprocessor, a second single chip microprocessor, and a HUD; wherein:
said GPS module has an input terminal electrically connected to a GPS antenna and a low noise amplifying circuit, respectively, and has an output terminal electrically connected to said bluetooth module and said first single chip microprocessor;
said bluetooth module has an input terminal electrically connected to a bluetooth antenna;
said first single chip microprocessor has an input terminal is electrically to said GPS module, said bluetooth module and said second single chip microprocessor;
said second single chip microprocessor has its input terminal electrically connected to said first single chip microprocessor;
said HUD is electrically connected to the output terminal of said second single chip microprocessor;
said HUD serves to project the information of the vehicle, such as speed, position, rotation, and time of stop, etc, onto the windscreen so that the driver may keep looking forward and concentrating on driving without lowering head from time to time to read the rotation meter and speed meter, thus improving driving safety, said bluetooth module wirelessly transmits the display and the data of the satellite positioning device to electronic products and mobile devices, so that these equipments and the satellite are interconnected.

2. The global positioning device with a HUD as claimed in claim 1, wherein the input terminal of said first single chip microprocessor is electrically connected to a power source switch.

3. The global positioning device with a HUD as claimed in claim 1, wherein the output terminal of said first single chip microprocessor is electrically connected to a GPS display light.

4. The global positioning device with a HUD as claimed in claim 1, wherein the input terminal of said first single chip microprocessor is electrically connected to an output terminal of a rotation detecting circuit.

5. The global positioning device with a HUD as claimed in claim 1, wherein the input terminal of said second single chip microprocessor is electrically connected to a light sensor.

6. The global positioning device with a HUD as claimed in claim 1 2, 3, 4 or 5, wherein an input terminal of a 12V vehicle power supply may be utilized to supply power and to electrically connect to a power conversion circuit.
